(19) United States
(12) Patent Application Publication
(10) Pub. No.: US 2023/0097951 A1
(43) Pub. Date: Mar. 30, 2023

(54) GREENHOUSE-LINKED AIR CONDITIONING SYSTEM AND AIR CONDITIONING METHOD USING THE SAME

(71) Applicant: University of Seoul Industry Cooperation Foundation, Seoul (KR)

(72) Inventors: Jung Ho HUH, Seoul (KR); Young Hoon KWAK, Seoul (KR); Hak Jong SHIN, Seoul (KR); Ja Bin GOO, Seoul (KR)

(21) Appl. No.: 17/953,039

(22) Filed: Sep. 26, 2022

(30) Foreign Application Priority Data
Sep. 29, 2021 (KR) 10-2021-0129116

(51) Int. Cl. A01G 9/24; A01G 9/14; F24F 11/30; F24F 11/54

(52) U.S. Cl. CPC A01G 9/246; A01G 9/14; F24F 11/30; F24F 11/54

(57) ABSTRACT

A greenhouse-linked air conditioning system includes a first greenhouse through which sunlight is transmitted and in which plants are grown, a second greenhouse through which sunlight is not transmitted and in which plants are grown, an indoor space excluding the first and second greenhouses in a building, a sunlight panel formed outside the first greenhouse and generating power using the sunlight, an auxiliary light source connected to the sunlight panel to provide light to the second greenhouse, and an air conditioning unit configured to connect the first and second greenhouses and the indoor space and selectively exchange air, humidity, and energy between the first and second greenhouses and the indoor space.

### CROSS-REFERENCE TO RELATED APPLICATION

This application claims priority to and the benefit of Korean Patent Application No. 10-2021-0129116 filed in the Korean Intellectual Property Office on Sep. 29, 2021, the entire contents of which are incorporated herein by reference.

### BACKGROUND

### Field

The present disclosure relates to a greenhouse-linked air conditioning system and an air conditioning method using the same.

### Description of the Related Art

A greenhouse is a structure that allows the cultivation of various plants freely by controlling light, temperature, and humidity. By using a greenhouse, plants can be grown in cold weather or plants grown in hot regions can be grown in cold regions, and flowering and fruiting can be controlled. Therefore, facilitation cultivation and suppression cultivation are possible.

In general, air inside a building uses an air conditioning system equipped with an air filter to maintain conditions such as temperature, humidity, and odor in the room in a state suitable for the purpose of use of the building. However, since the existing air conditioning system purifies the air using a mechanical method, there is a disadvantage to supplying artificial air instead of natural air. Moreover, in this case, there is a disadvantage that the window of the building should be opened periodically to bring in fresh air from outside.

Accordingly, when plants are cultivated in an indoor space for indoor air conditioning, plants can absorb carbon dioxide emitted from a human body, provide oxygen necessary for the human body, and provide emotional richness or aesthetic function. However, there is a disadvantage that there is not enough space for planting in the indoor space inside the building, and the optimal air conditioning effect cannot be obtained because the air conditions for plant cultivation and the air conditions according to the purpose of use of the building are different.

### SUMMARY

In order to solve the above problem, an object of the present disclosure is to provide a greenhouse-linked air conditioning system and an air conditioning method using the same capable of selectively exchanging air, humidity, and energy between a greenhouse and an indoor space by connecting the greenhouse and the indoor space.

According to an aspect of the present disclosure, there is provided a greenhouse-linked air conditioning system including: a first greenhouse through which sunlight is transmitted and in which plants are grown; a second greenhouse through which sunlight is not transmitted and in which plants are grown; an indoor space excluding the first and second greenhouses in a building; a sunlight panel formed outside the first greenhouse and generating power using the sunlight; an auxiliary light source connected to the sunlight panel to provide light to the second greenhouse; and an air conditioning unit configured to connect the first and second greenhouses and the indoor space and selectively exchange air, humidity, and energy between the first and second greenhouses and the indoor space.

The second greenhouse may be located in a basement of the building.

The air conditioning unit may include a duct as a passage through which the air flows between the first and second greenhouses and the indoor space, a sensor module coupled to the duct to measure a state of the air, a damper coupled to the duct to control opening or closing of the duct, an air supply fan coupled to the duct to allow air to flow through the duct, and an integrated control unit connected to the sensor module, the damper, and the air supply fan to control driving of the damper and the air supply fan, in which the dampers may be operated in conjunction with each other to facilitate the flow of the air.

The air conditioning unit may further include a filter coupled to the duct to filter out contaminants before the air is introduced into the first and second greenhouses and the indoor space.

The sensor module may include a CO2 sensor configured to measure a CO2 concentration of the air, an air quality sensor configured to measure a concentration of contaminants in the air, a temperature sensor configured to measure a temperature of the air, and a humidity sensor configured to measure a humidity of the air.

The air conditioning unit may further include a dehumidifier coupled to the duct to reduce the humidity before the air is introduced into the indoor space.

The air conditioning unit may further include a cooling coil and a heater coil configured to control a temperature before the air is introduced into the indoor space.

According to another aspect of the present disclosure, there is provided an air conditioning method using the greenhouse-linked air conditioning system according to one aspect of the present disclosure, the air conditioning method including: introducing outside air after measuring a condition of the air; mixing the introduced outside air with air passing through at least one of the first and second greenhouses; controlling and purifying temperature and humidity of the mixed air; and providing the mixed air to the indoor space.

The air conditioning method may further include, after the providing of the mixed air to the indoor space, determining a path of the air passing through the indoor space by controlling the damper according to whether the first and second greenhouses are used.

The air conditioning method may further include, after the determining of the path of the air passing through the indoor space by controlling the damper, additionally supplying CO2 through combustion of a boiler only when a CO2 concentration of the air passing through the indoor space is smaller than an appropriate CO2 concentration of the first and second greenhouses in a case where the first and second greenhouses are used.

The air conditioning method may further include, after the determining of the path of the air passing through the indoor space by controlling the damper, controlling ventilation and humidity of the greenhouse itself according to a measurement value of the sensor module in a case where the first and second greenhouses are used.

The air conditioning method of may further include, after the controlling of the ventilation and humidity of the greenhouse itself according to the measurement value of the sensor module, determining the path of the air passing through the greenhouse according to the measurement value of the sensor module.

As described above, the greenhouse-linked air conditioning system and the air conditioning method using the same according to an aspect of the present disclosure can selectively exchange air, humidity and energy between the greenhouse and the indoor space.

### BRIEF DESCRIPTION OF THE DRAWINGS

The above and other aspects will become more apparent from the following description of the exemplary embodiments with reference to the accompanying drawings, in which:

FIG. 1 is a diagram schematically illustrating a greenhouse-linked air conditioning system according to a first embodiment of the present disclosure;

FIG. 2 is a configuration diagram illustrating the overall configuration of the greenhouse-linked air conditioning system of FIG. 1;

FIG. 3 is a view illustrating a connection structure of an integrated control unit of the greenhouse-linked air conditioning system of FIG. 1;

FIG. 4 is a flowchart illustrating a process of an air conditioning method using a greenhouse-linked air conditioning system according to a first, embodiment of the present disclosure;

FIG. 5 is a configuration diagram illustrating the overall configuration of a greenhouse-linked air conditioning system according to a second embodiment of the present disclosure;

FIG. 6 is a flowchart illustrating a process of an air conditioning method using the greenhouse-linked air conditioning system according to the second embodiment of the present disclosure; and

FIG. 7 is a diagram illustrating a computing device according to an embodiment of the present disclosure.

### DETAILED DESCRIPTION

Hereinafter, with reference to the accompanying drawings, embodiments of the present disclosure will be described in detail so that those of ordinary skill in the art to which the present disclosure pertains can easily implement them. However, the present disclosure may be embodied in various different forms and is not limited to the embodiments described herein. Moreover, in order to clearly explain the present disclosure in the drawings, parts irrelevant to the description are omitted, and similar reference numerals are attached to similar parts throughout the specification.

In the present specification and drawings (hereinafter “the present specification”), duplicate descriptions of the same components will be omitted.

Moreover, in the present specification, when an element is referred to as being “coupled” or “connected” to another element, it may be directly coupled or connected to the other element, but it should be understood that other elements may exist therebetween. Meanwhile, in the present specification, when it is mentioned that an element is “directly coupled” or “directly connected” to another element, it should be understood that other elements do not exist therebetween.

In addition, the terms used herein are used only to describe specific embodiments, and are not intended to limit the present disclosure.

Moreover, in the present specification, the singular expression may include the plural expression unless the context clearly dictates otherwise.

In addition, in the present specification, terms such as “comprise” or “have” are only intended to designate that the features, numbers, steps, operations, components, parts, or combinations thereof described in the specification exist, and it should be understood that the existence or addition of one or more other features, numbers, steps, operations, components, parts, or combinations thereof is not precluded in advance.

Further, in the present specification, the term “and/or” includes a combination of a plurality of listed items or any of a plurality of listed items. In the present specification. “A or B” may include “A”, “B”, or “both A and B”.

Also, in the present specification, detailed descriptions of well-known functions and configurations that may obscure the gist of the present disclosure will be omitted.

Hereinafter, a greenhouse-linked air conditioning system 10 according to a first embodiment of the present disclosure will be described.

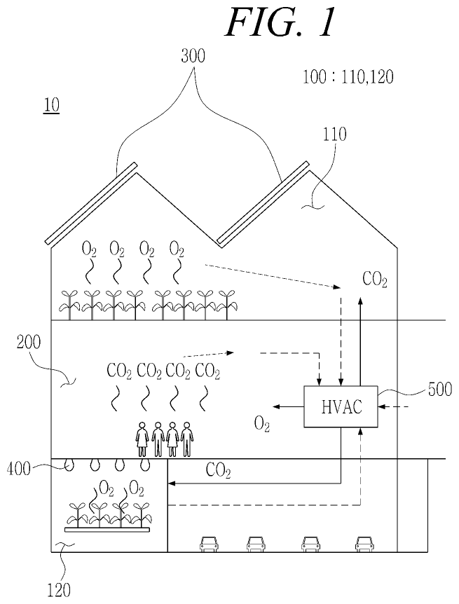

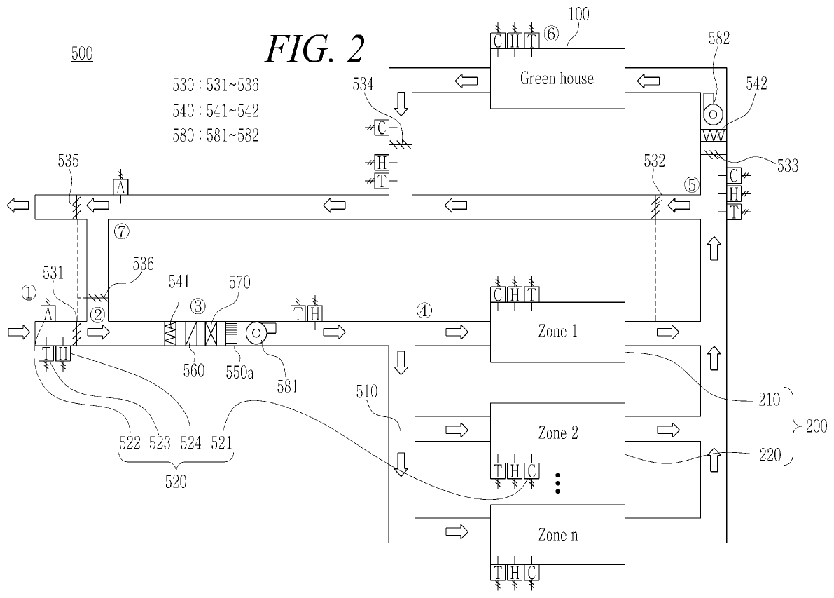

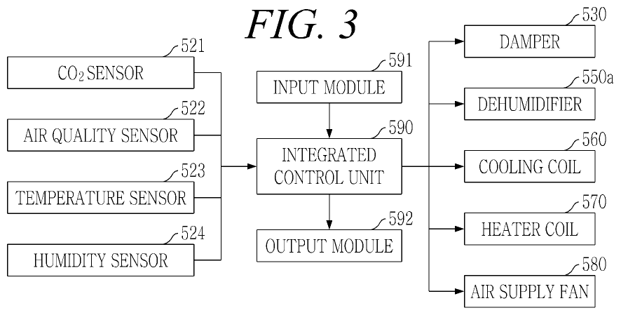

FIG. 1 is a diagram schematically illustrating a greenhouse-linked air conditioning system according to a first embodiment of the present disclosure, FIG. 2 is a configuration diagram illustrating the overall configuration of the greenhouse-linked air conditioning system of FIG. 1, and FIG. 3 is a view illustrating a connection structure of an integrated control unit of the greenhouse-linked air conditioning system of FIG. 1.

Referring to FIGS. 1 to 3, the greenhouse-linked air conditioning system 10 according to the first embodiment of the present disclosure includes a greenhouse 100, an indoor space 200, a sunlight panel 300, an auxiliary light source 400, and an air conditioning unit 500. According to the present embodiment, the greenhouse 100 and the indoor space 200 may be connected to selectively exchange air, humidity, and energy with each other.

In addition, the sunlight panel 300 is installed outside the greenhouse 100 to produce necessary power, and by using the auxiliary light source 400 connected to the sunlight panel 300, the greenhouse 100 can be installed in a place where there is no light, for example, in the basement space of a building, thereby maximizing space utilization. Here, it can be understood by those of ordinary skill in the art related to this embodiment that general-purpose components other than those illustrated in FIGS. 1 to 3 may be further included in the greenhouse-linked air conditioning system 10 in addition to the components illustrated in FIGS. 1 to 3.

The greenhouse 100 is located in a building and is a space for cultivating plants therein, and may include a first greenhouse 110 and a second greenhouse 120. Here, it can be understood by those of ordinary skill in the art related to this embodiment that the greenhouse 100 is not necessarily limited to the first greenhouse 110 and the second greenhouse 120, and may further include several greenhouses 100 as needed.

The first greenhouse 110 is a space through which sunlight is transmitted and in which plants can be grown, and may be located inside the building. The first greenhouse 110 may be located at the top of the building, such as a roof of the building, in order to maximize an area through which sunlight can be transmitted. The first greenhouse 110 may include a side wall and an upper wall to form a space in which plants can be grown.

An outer wall of the first greenhouse 110 may be made of a transparent material such as glass, a transparent acrylic plate, and a plastic window to transmit sunlight. The bottom of the first greenhouse 110 may be formed of a material having low heat absorption or reflectance in order to prevent the transmitted sunlight from being not used in the greenhouse and being discarded. However, the location and material of the first greenhouse 110 are not limited thereto, and may be partially changed within a range that can be employed by a person skilled in the art.

The second greenhouse 120 is a space through which sunlight is not transmitted and in which plants can be grown, and location restrictions in the interior of the building may be small. The second greenhouse 120 may grow plants by receiving light necessary for plant growth from an auxiliary light source 400 to be described later even though sunlight is not transmitted therethrough.

The second greenhouse 120 may be located in the basement of the building. In general, the space in the basement of a building does not receive sunlight and is prone to mold due to high humidity and poor air circulation, and thus, the utilization of the basement is not high compared to the ground floor. Accordingly, by locating the second greenhouse 120 in the basement of the building, the space inside the building can be utilized to the maximum, and the air quality can be improved by photosynthesis and respiration of plants inside the greenhouse 100.

The second greenhouse 120 may include a side wall and an upper wall to form a space in which plants can be grown. The second greenhouse 120 may utilize the auxiliary light source 400 as the main light source, and unlike the first greenhouse 110 using sunlight as the main light source, the material of the outer wall does not need to be transparent. For a floor of the second greenhouse 120, a material having low heat absorption or reflectance may be selected in order to prevent the light of the auxiliary light source 400 from being not used in the greenhouse and is not discarded. However, the location and material of the second greenhouse 120 are not limited thereto, and may have various locations and materials.

The indoor space 200 is a space excluding the first greenhouse 110 and the second greenhouse 120 in the building, and may include a first indoor space 210 and a second indoor space 220. However, it can be understood by those of ordinary skill in the art related to the example that the first indoor space 210 and the second indoor space 220 are merely illustrative of the plurality of indoor spaces 200, and several indoor spaces 200 may be further included as necessary.

The indoor space 200 may be a residential space, a commercial space, a work space, a research space, or the like according to the purpose of use of the building. Depending on the purpose of use of the indoor space 200, the required air condition may be different. For example, when the indoor space 200 is used as a residential space, it should have adequate indoor humidity and oxygen concentration suitable for human habitation, and when a high-end PC is equipped, such as a computer room, a certain temperature should be maintained to avoid overheating of the computer and disk. The indoor space 200 may selectively exchange air, humidity, and energy with the greenhouse 100 by the air conditioning unit 500 to be described later according to the required air condition of the indoor space 200.

The sunlight panel 300 may be formed outside the first greenhouse 110 to generate power using sunlight. The sunlight panel 300 may be positioned on the upper portion of the first greenhouse 110 and may have a thin plate shape inclined at a predetermined angle to maximize an area receiving sunlight. The sunlight panel 300 may be made of a crystalline silicon material containing little heavy metal in order to prevent environmental pollution by heavy metals.

The sunlight panel 300 is provided with a driving unit (not illustrated) to control the angle and position of the sunlight panel 300 itself according to the angle of incidence and reflection of the sunlight. Heat generated by the sunlight panel 300 may provide heating to the greenhouse 100 and the indoor space 200. The sunlight panel 300 may use sunlight to generate power and use the power as an energy source for the auxiliary light source 400 and the air conditioning unit 500 to be described later. However, the shape and material of the sunlight panel 300 are not limited thereto, and may be changed within a range that can be employed by a person skilled in the art.

The auxiliary light source 400 may be connected to the sunlight panel 300 to provide light to the second greenhouse 120. The auxiliary light source 400 may be spaced apart from each other at regular intervals in the upper portion of the second greenhouse 120 to evenly provide light to the second greenhouse 120. The auxiliary light source 400 may control the angle according to the degree necessary for the growth of plants.

As the auxiliary light source 400, an incandescent light bulb, a fluorescent lamp, an HID lamp, or the like that generates heat and light by utilizing the power generated by the sunlight panel 300 may be used. As the auxiliary light source 400 is present, there is an advantage that plants can be grown by installing the second greenhouse 120 even in a space where sunlight does not reach. However, the position and type of the auxiliary light source 400 are not limited thereto and may be changed within a range that can be employed by a person skilled in the art.

The air conditioning unit 500 may include a duct 510, a sensor module 520, a damper 530, a filter 540, a dehumidifier 550a, a cooling coil 560, a heater coil 570, an air supply fan 580, and an integrated control unit 590. The air conditioning unit 500 connects the first greenhouse 110 and the second greenhouse 120 and the indoor space 200, and may selectively change air, humidity, and energy between the first greenhouse 110 and the second greenhouse 120 and the indoor space 200. Heating, ventilation, and air conditioning (HVAC) may be utilized for the air conditioning unit 500 (refer to FIG. 1). Here, it can be understood by those of ordinary skill in the art related to the present embodiment that other general-purpose components other than those illustrated in FIGS. 1 to 3 may be further included in the air conditioning unit 500.

The duct 510 may be a passage through which air flows between the first greenhouse 110 and the second greenhouse 120 and the indoor space 200. The duct 510 may have a rectangular cross-section or may be a pipe or tube having a circular or oval shape in order to reduce friction between the duct 510 and air. The duct 510 may have a closed structure to prevent contact with outside air while the air flows.

The duct 510 may be made of a steel plate, an aluminum plate, polyvinyl chloride (PVC), or fiber reinforced plastics (FRP) having sufficient rigidity to maintain a shape even under a continuous load. In the duct 510, an insulating material is wrapped around the duct 510 to prevent heat transfer between the inside and the outside of the duct 510. However, the shape and material of the duct 510 are not limited thereto, and may be changed within a range that can be employed by a person skilled in the art.

The sensor module 520 may include a CO2 sensor 521, an air quality sensor 522, a temperature sensor 523, and a humidity sensor 524. The sensor module 520 may be coupled to the duct 510 to measure the state of air. Here, it can be understood by those of ordinary skill in the art related to the present embodiment that other general-purpose sensors in addition to the sensors illustrated in FIGS. 1 to 3 may be further included in the sensor module 520.

The CO2 sensor 521 may be coupled to the indoor space 200 and the greenhouse 100 to measure the concentration of CO2 contained in the air. The CO2 sensor 521 may be any sensor for measuring the CO2 concentration. For example, the CO2 sensor 521 may be a Non-Dispersive Infrared (NDIR) sensor capable of measuring the CO2 concentration.

The CO2 sensor 521 is located in the greenhouse 100, and may provide an indicator for determining whether the air inside the greenhouse 100 corresponds to a condition in which a plant can photorespiration.

The CO2 sensor 521 is located in the indoor space 200, and may provide an indicator for determining whether the air inside the indoor space 200 meets the air conditions according to a user's residence and living or the purpose of use of the building.

In addition, the CO2 sensor 521 may be coupled to the duct 510 before the air flows into the greenhouse 100 to measure the CO2 concentration of the air flowing into the greenhouse 100. When the CO2 concentration measured by the CO2 sensor 521 is smaller than the CO2 concentration for photorespiration of plants inside the greenhouse 100, CO2 may be additionally supplied through combustion of a boiler 550b.

The CO2 sensor 521 may be coupled to the duct 510 through which air flows out of the greenhouse 100 to measure the CO2 concentration of the air flowing out of the greenhouse 100. When the CO2 concentration measured by the CO2 sensor 521 is not suitable for the resident. CO2 may be exhausted to the outside of the building using the damper 530 to be described later. However, the position and type of the CO2 sensor 521 are not limited thereto, and may have various positions and types.

The air quality sensor 522 may be coupled to the duct 510 to measure fine dust, living gas, and harmful substances in the air. The air quality sensor 522 may be any sensor for measuring air quality. For example, the air quality sensor 522 may be a laser fine dust sensor, a non-dispersive infrared sensor (NDIR), and a volatile organic compounds (VOC) sensor.

A plurality of air quality sensors 522 may be coupled to the duct 510 as necessary. For example, the air quality sensor 522 may be coupled to the duct 510 of the part through which the outside air flows into the building, and measure the quality of the outside air when outside air is introduced to provide an indicator for determining whether outside air is introduced.

In addition, the air quality sensor 522 may be coupled to the duct 510 of the portion through which the air passing through the greenhouse 100 passes, and measure the air quality of the air passing through the greenhouse 100 to provide an indicator for determining whether the air is introduced into the indoor space 200. However, the position and type of the air quality sensor 522 are not limited thereto, and may have various positions and types.

The temperature sensor 523 and the humidity sensor 524 may be coupled to the duct 510 to measure the temperature and humidity of the air. The temperature sensor 523 and the humidity sensor 524 may be any sensor for measuring the temperature and humidity of air. For example, the temperature sensor 523 may be a thermistor, a resistance temperature detector (RTD), an infrared temperature sensor, or the like. The humidity sensor 524 may be a lithium chloride humidity sensor, an aluminum oxide humidity sensor, a ceramic humidity sensor, or the like.

A plurality of temperature sensors 523 and humidity sensors 524 may be coupled to the duct 510 as necessary. For example, the temperature sensor 523 and the humidity sensor 524 may be coupled to the duct 510 of the part through which the outside air flows into the building, and measure the temperature and humidity of the outside air when the outside air is introduced to provide an indicator for determining whether outside air is introduced.

The temperature sensor 523 and the humidity sensor 524 may be located in the greenhouse 100, and may provide an indicator for determining whether the air inside the greenhouse 100 corresponds to a condition in which a plant can take photorespiration.

In addition, the temperature sensor 523 and the humidity sensor 524 may be located in the indoor space 200, and may provide an indicator for determining whether the air inside the indoor space 200 meets the air conditions according to the purpose of the user's residence and living area or building.

The temperature sensor 523 and the humidity sensor 524 may be coupled to the duct 510 before the air flows into the indoor space 200 to measure the temperature and humidity of the air flowing into the indoor space 200. When the temperature and humidity measured by the temperature sensor 523 are unsuitable for the purpose of use of the occupants and users or the building inside the indoor space 200, the dehumidifier 550a, the cooling coil 560, and the heater coil 570 to be described later may be used to control temperature and humidity. However, the positions and types of the temperature sensor 523 and the humidity sensor 524 are not limited thereto and may have various positions and types.

The damper 530 may include a first damper 531, a second damper 532, a third damper 533, a fourth damper 534, a fifth damper 535, and a sixth damper 536. The damper 530 may be coupled to the duct 510 to control opening or closing of the duct 510. However, it can be understood by those of ordinary skill in the art related to the present embodiment that the first to sixth dampers 531, 532, 533, 534, 535, and 536 are merely illustrative of the plurality of dampers 530, and if necessary, more dampers 530 may be included.

The damper 530 may determine a path of air flowing inside the duct 510. For example, when the air ventilated in the greenhouse 100 is unsuitable for the purpose of use of the occupants and users or the building, the damper 530 facing the outside of the building is opened to exhaust the air ventilated from the greenhouse 100 to the outside.

The damper 530 may be any damper 530 installed in the duct 510 to control the amount of air blown. For example, the damper 530 may be a rotary damper, a butterfly damper, and a split damper. However, the position and type of the damper 530 are not limited thereto and may have various positions and types.

The filter 540 may include a first filter 541 and a second filter 542. The filter 540 may be coupled to the duct 510 to filter pollutants before the air is introduced into the first greenhouse 110, the second greenhouse 120, and the indoor space 200. The filter 540 may be made of filter paper in which small holes are formed in order to remove dust or various particles from the air when the air flows.

The filter 540 may be coupled to the duct 510 of the portion before the air flows into the greenhouse 100 and the indoor space 200 to purify the incoming air. However, the position and type of the filter 540 are not limited thereto and may have various positions and types.

The dehumidifier 550a may be coupled to the duct 510 to reduce the humidity before the air flows into the indoor space 200. A plurality of dehumidifiers 550a may be coupled to the duct 510 as necessary. For example, the dehumidifier 550a may be coupled to the duct 510 of a portion in which air is introduced into the indoor space 200 and the greenhouse 100 to control the humidity of the incoming air. The dehumidifier 550a may have any configuration for lowering the humidity of the air.

The cooling coil 560 and the heater coil 570 may be coupled to the duct 510 to control the temperature before air is introduced into the indoor space 200. A plurality of cooling coils 560 and heater coils 570 may be coupled to the duct 510 as necessary.

The air supply fan 580 may include a first air supply fan 581 and a second air supply fan 582. The air supply fan 580 may be coupled to the duct 510 to allow air inside the duct 510 to flow. Here, the first air supply fan 581 and the second air supply fan 582 are merely illustrative of the air supply fan 580, and the air supply fan 580 may be coupled to a plurality of the duct 510 as necessary.

The integrated control unit 590 may be connected to the sensor module 520, the damper 530, and the air supply fan 580 to control driving of the damper 530 and the air supply fan 580. The integrated control unit 590 may perform calculation for driving the damper 530 and the air supply fan 580 based on the signal received from the sensor module 520.

In addition, the dehumidifier 550a, the cooling coil 560, and the heater coil 570 may be connected to the integrated control unit 590, and based on the signal received from the sensor module 520, the calculation for driving the dehumidifier 550a, the cooling coil 560, and the heater coil 570 may be performed. The integrated control unit 590 may be a single control board including a high-performance computing unit processor, such as a GPU board. However, the integrated control unit 590 may have any configuration that enables calculation for driving the damper 530, the air supply fan 580, the dehumidifier 550a, the cooling coil 560, and the heater coil 570.

The input module 591 and the output module 592 may be connected to the integrated control unit 590 to input an input signal or output a control signal of the integrated control unit 590. The input module 591 and the output module 592 may have any configuration for input/output. For example, the input module 591 may be a touch pad or an input keypad, and the output module 592 may be an LCD panel.

When the input module 591 and the output module 592 are utilized, the state of the air measured using the sensor module 520 may be checked and manual operation of the air conditioning unit 500 may be possible.

Hereinafter, an air conditioning method using a greenhouse-linked air conditioning system 10 according to a first embodiment of the present disclosure will be described.

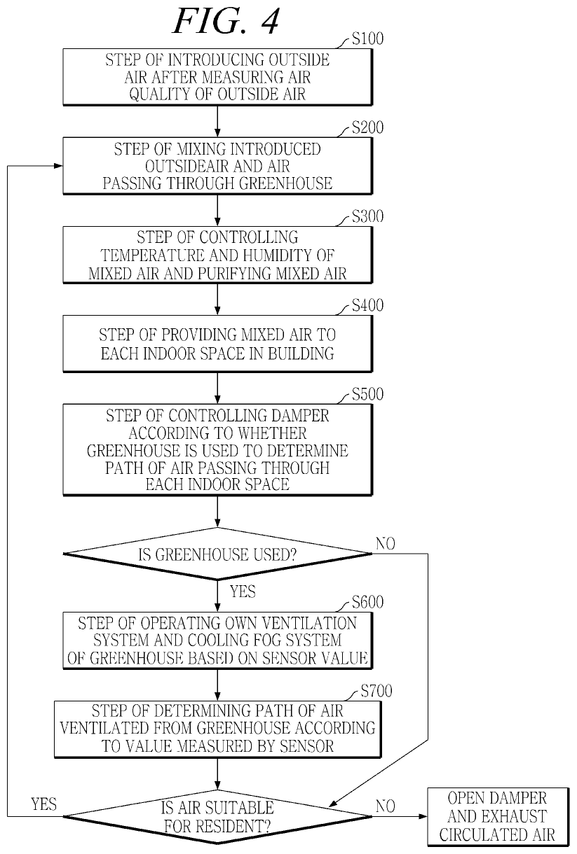

FIG. 4 is a flowchart illustrating a process of an air conditioning method using a greenhouse-linked air conditioning system according to a first embodiment of the present disclosure.

Referring to FIG. 4, the air conditioning method using the greenhouse-linked air conditioning system 10 may include a step of introducing outside air (S100), a step of mixing air (S200), a step of controlling the temperature and humidity of the mixed air and purifying the air (S300), providing the mixed air to the indoor space 200 (S400), determining the path of the air passing through the indoor space 200 according to whether the greenhouse 100 is used (S500), a step of controlling the ventilation and humidity of the greenhouse 100 itself (S600), and a step of determining the path of air passing through the greenhouse 100 (S700).

Through the above series of steps, the energy efficiency of the building can be increased by using the waste heat inside the building as heating and cooling necessary for growing crops in the greenhouse. In addition, fine dust inside the building and CO2 increased by the breathing of the occupants can be removed by the filter 540 and photosynthesis and respiration of the plants inside the greenhouse 100, and thus, air quality can be improved.

Referring to FIGS. 2 and 4, in the step of introducing the outside air (S100), the temperature, humidity, fine dust, and harmful substances of the outside air may be sensed by the sensor module 520. In addition, when it is determined by the integrated control unit 590 that the air quality is suitable for the air quality according to the purpose of use of the resident and user in the building, the first damper 531 may be operated to introduce outside air.

The introduced outside air in the step of mixing the air and the air passing through at least one of the first greenhouse 110 and the second greenhouse 120 may be mixed. The sixth damper 536 may be operated to introduce air passing through at least one of the first greenhouse 110 and the second greenhouse 120 to be mixed with the outside air.

In the step of controlling the temperature and humidity of the mixed air and purifying the air (S300), the air mixed by the first filter 541, the cooling coil 560, the heater coil 570, and the dehumidifier 550a can be suitable for the indoor space 200. Fine dust and various particles may be filtered by the first filter 541. The air mixed by the cooling coil 560 and the heater coil 570 may be made to a temperature required for the indoor space 200. The dehumidifier 550a may be operated to control the humidity when the humidity of the mixed air measured by the humidity sensor 524 indicates a humidity greater than or equal to the comfortable range.

In the step of providing the mixed air to the indoor space 200 (S400), the first air supply fan 581 is driven, and thus, the mixed air may be provided to all indoor spaces of the building including the first indoor space 210 and the second indoor space 220.

In the step of determining the path of the air passing through the indoor space 200 (S500), the damper 530 may be controlled to determine the path of the air passing through the indoor space 200 according to whether the greenhouse is used. When the greenhouse 100 is used, the integrated control unit 590 closes the second damper 532 and opens the third damper 533 to control the air passing through the indoor space 200 toward the greenhouse 100. When the greenhouse 100 is not used, the integrated control unit 590 opens the second damper 532 and closes the third damper 533 to control the air passing through the indoor space 200 not to pass through the greenhouse 100.

In the step of controlling the ventilation and humidity of the greenhouse 100 itself (S600), the own ventilation and fog system of the greenhouse 100 may be operated based on the sensor value measured by the sensor module 520. Through the step of controlling the ventilation and humidity of the greenhouse 100 itself (S600), the air inside the greenhouse 100 may maintain an appropriate state for the growth of plants.

In the step of determining the path of the air passing through the greenhouse 100 (S700), the path of the air passing through the greenhouse 100 may be determined by controlling the damper 530 according to the measured value of the sensor module 520. When it is determined by the measured value of the sensor module 520 that the air passing through the greenhouse 100 meets the air conditions according to the purpose of use of the resident and the building, the integrated control unit 590 closes the fifth damper 535 and opens the sixth damper 536 so that the air passing through the greenhouse 100 is mixed with the introduced outside air. When it is determined by the measurement value of the sensor module 520 that the air passing through the greenhouse 100 does not meet the air conditions according to the purpose of use of the resident and the building, the integrated control unit 590 opens the fifth damper 535 and closes the sixth damper 536 so that the air passing through the greenhouse 100 is exhausted to the outside.

Hereinafter, a greenhouse-linked air conditioning system 10 according to a second embodiment of the present disclosure and an air conditioning method using the same will be described.

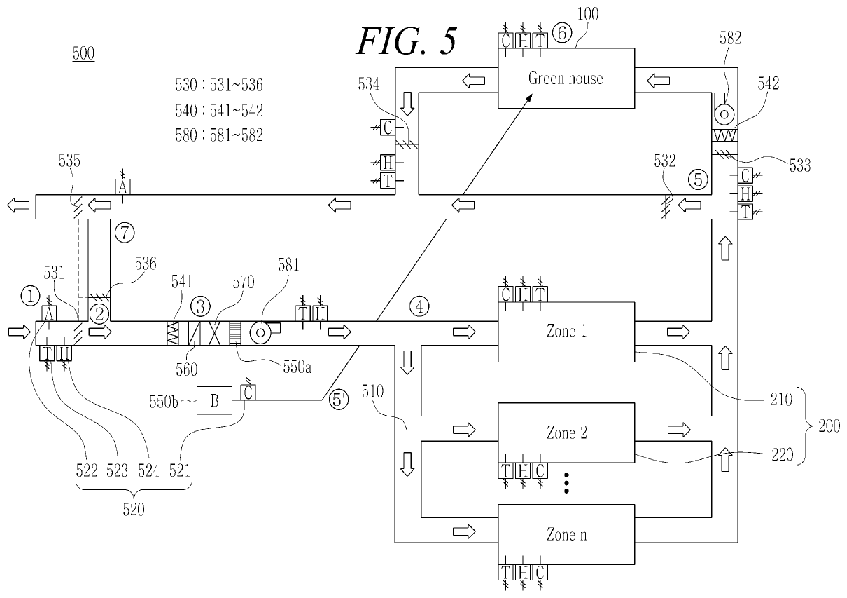

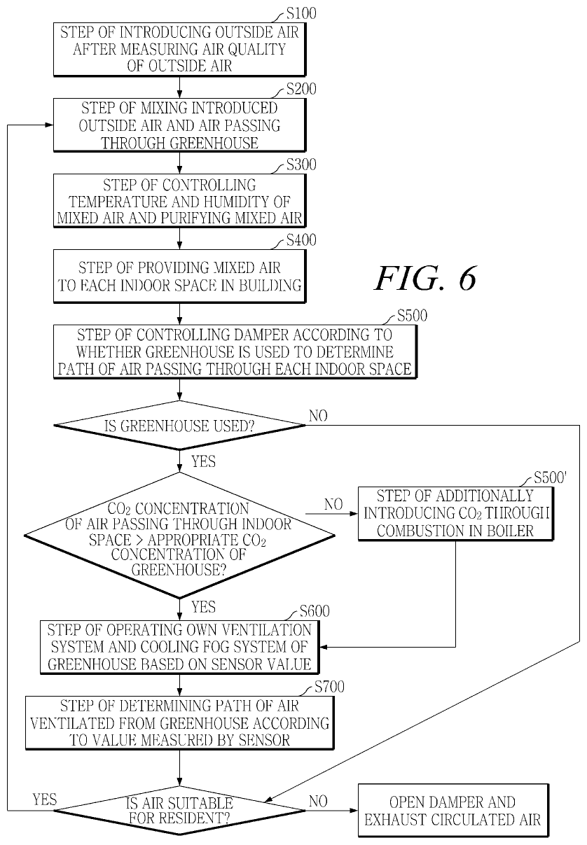

FIG. 5 is a configuration diagram illustrating the overall configuration of a greenhouse-linked air conditioning system according to a second embodiment of the present disclosure, and FIG. 6 is a flowchart illustrating a process of an air conditioning method using the greenhouse-linked air conditioning system according to the second embodiment of the present disclosure.

Referring to FIGS. 5 and 6, the greenhouse-linked air conditioning system 10 and the air conditioning method using the same according to the second embodiment of the present disclosure include the same structure and steps as those of the greenhouse-linked air conditioning system 10 and the air conditioning method using the same according to the first embodiment except that a boiler 550b and a step of additionally provided CO2 are provided, and thus, repeated descriptions will be omitted.

According to this embodiment, the boiler 550b installed inside the building may be utilized for heating the greenhouse 100 and the indoor space 200, and may also supply CO2 for an appropriate CO2 concentration of the greenhouse 100.

In the step (S500′) of additionally supplying CO2, when the CO2 concentration of the air passing through the indoor space 200 measured by the sensor module 520 is smaller than the appropriate CO2 concentration for photosynthesis and respiration of plants inside the greenhouse 100, CO2 generated by combustion of the boiler 550b may be additionally supplied to the greenhouse 100. Through the step of additionally supplying CO2 (S500′), it is possible to efficiently remove the CO2 generated in the building and easily maintain the CO2 concentration for the cultivation of plants inside the greenhouse 100.

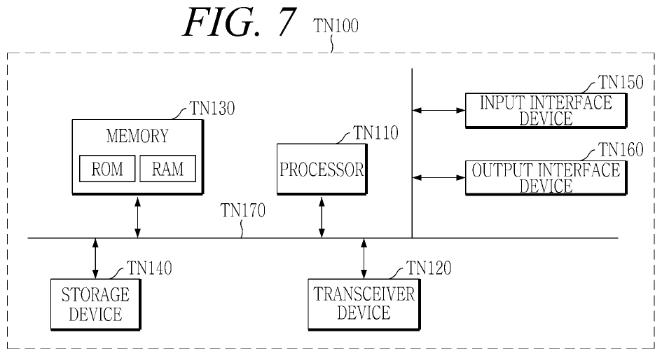

FIG. 7 is a diagram illustrating a computing device according to an embodiment of the present disclosure. A computing device TN100 may be a device related to the greenhouse-linked air conditioning system 10.

The computing device TN100 may include at least one processor TN110, a transceiver device TN120, and a memory TN130. Moreover, the computing device TN100 may further include a storage device TN140, an input interface device TN150, an output interface device TN160, and the like. Components included in the computing device TN100 may be connected to a bus TN170 to communicate with each other.

The processor TN110 may execute a program command stored in at least one of the memory TN130 and the storage device TN140. The processor TN110 may mean a central processing unit (CPU), a graphics processing unit (GPU), or a dedicated processor on which methods according to an embodiment of the present disclosure are performed. The processor TN110 may be configured to implement procedures, functions, and methods described in connection with an embodiment of the present disclosure. The processor TN110 may control each component of the computing device TN100.

Each of the memory TN130 and the storage device TN140 may store various information related to the operation of the processor TN110. Each of the memory TN130 and the storage device TN140 may be configured as at least one of a volatile storage medium and a non-volatile storage medium. For example, the memory TN130 may include at least one of a read only memory (ROM) and a random access memory (RAM).

The transceiver TN120 may transmit or receive a wired signal or a wireless signal. The transceiver TN120 may be connected to a network to perform communication.

Meanwhile, the embodiments of the present disclosure are not implemented only through the device and/or method described so far, and may be implemented through a program for realizing functions corresponding to the configurations of the embodiments of the present disclosure or a recording medium in which the program is recorded, and the implementations can be easily implemented by those skilled in the art to which the present disclosure pertains from the descriptions of the above-described embodiments.

Although the embodiments of the present disclosure have been described in detail above, the scope of the present disclosure is not limited thereto, and various modifications and improved forms of those skilled in the art using the basic concept of the present disclosure defined in the following claims also fall within the scope of the present disclosure.

What is claimed is:

1. A greenhouse-linked air conditioning system comprising:
a first greenhouse through which sunlight is transmitted and in which plants are grown;
a second greenhouse through which sunlight is not transmitted and in which plants are grown;
an indoor space excluding the first and second greenhouses in a building;
a sunlight panel formed outside the first greenhouse and generating power using the sunlight;
an auxiliary light source connected to the sunlight panel to provide light to the second greenhouse; and
an air conditioning unit configured to connect the first and second greenhouses and the indoor space and selectively exchange air, humidity, and energy between the first and second greenhouses and the indoor space.

2. The greenhouse-linked air conditioning system of claim 1, wherein the second greenhouse is located in a basement of the building.

3. The greenhouse-linked air conditioning system of claim 1, wherein the air conditioning unit includes
a duct as a passage through which the air flows between the first and second greenhouses and the indoor space,
a sensor module coupled to the duct to measure a state of the air,
a damper coupled to the duct to control opening or closing of the duct,
an air supply fan coupled to the duct to allow air to flow through the duct, and
an integrated control unit connected to the sensor module, the damper, and the air supply fan to control driving of the damper and the air supply fan,
wherein the dampers are operated in conjunction with each other to facilitate the flow of the air.

4. The greenhouse-linked air conditioning system of claim 3, wherein the air conditioning unit further includes a filter coupled to the duct to filter out contaminants before the air is introduced into the first and second greenhouses and the indoor space.

5. The greenhouse-linked air conditioning system of claim 4, wherein the sensor module includes
a CO2 sensor configured to measure a CO2 concentration of the air,
an air quality sensor configured to measure a concentration of contaminants in the air,
a temperature sensor configured to measure a temperature of the air, and
a humidity sensor configured to measure a humidity of the air.

6. The greenhouse-linked air conditioning system of claim 5, wherein the air conditioning unit further includes
a dehumidifier coupled to the duct to reduce the humidity before the air is introduced into the indoor space, and
a cooling coil and a heater coil configured to control a temperature before the air is introduced into the indoor space.

7. An air conditioning method using the greenhouse-linked air conditioning system according to claim 1, the air conditioning method comprising:
introducing outside air after measuring a condition of the air;
mixing the introduced outside air with air that has passed through at least one of the first and second greenhouses;
controlling and purifying temperature and humidity of the mixed air; and
providing the mixed air to the indoor space.

8. The air conditioning method of claim 7, further comprising, after the providing of the mixed air to the indoor space, determining a path of the air passing through the indoor space by controlling the damper according to whether the first and second greenhouses are used.

9. The air conditioning method of claim 8, further comprising, after the determining of the path of the air passing through the indoor space by controlling the damper, additionally supplying CO2 through combustion of a boiler only when a CO2 concentration of the air passing through the indoor space is smaller than an appropriate CO2 concentration of the first and second greenhouses in a case where the first and second greenhouses are used.

10. The air conditioning method of claim 9, further comprising, after the determining of the path of the air passing through the indoor space by controlling the damper, controlling ventilation and humidity of the greenhouse itself according to a measurement value of the sensor module in a case where the first and second greenhouses are used.

11. The air conditioning method of claim 10, further comprising, after the controlling of the ventilation and humidity of the greenhouse itself according to the measurement value of the sensor module, determining the path of the air passing through the greenhouse according to the measurement value of the sensor module.
